(19) United States
(12) Patent Application Publication
(10) Pub. No.: US 2023/0105109 A1
(43) Pub. Date: Apr. 6, 2023

(54) COOLING TOWER CONTROL METHOD AND SYSTEM

(71) Applicant: FORMOSA HEAVY INDUSTRIES CORPORATION, Kaohsiung City (TW)

(72) Inventors: Gu-Chuan TSIOU, New Taipei City (TW); Hsien-Hui HUANG, Kaohsiung City (TW); Chia-Hung YEN, Changhua City (TW); Chang-Da WU, Kaohsiung City (TW); Yu-Lin HSIEH, Taichung City (TW)

(73) Assignee: FORMOSA HEAVY INDUSTRIES CORPORATION, Kaohsiung City (TW)

(21) Appl. No.: 17/957,596

(22) Filed: Sep. 30, 2022

(30) Foreign Application Priority Data
Oct. 1, 2021 (TW) 110136702

(51) Int. Cl. F28F 27/00; G05B 19/4155

(52) U.S. Cl. CPC F28F 27/003; G05B 19/4155; G05B 2219/49216

(57) ABSTRACT

A cooling tower control method, used for controlling a cooling tower having at least one sensor, includes: receiving and processing a received sensor data; based on the received sensor data, timing training a water outlet temperature prediction model; receiving a target water outlet temperature; traverse searching a plurality of control parameter combinations meeting the target water outlet temperature; selecting an energy-saving target control parameter combination from the plurality of control parameter combinations meeting the target water outlet temperature; and controlling the cooling tower based on the target control parameter combination.

This application claims the benefit of Taiwan application Serial No. 110136702, filed Oct. 1, 2021, the subject matter of which is incorporated herein by reference.

### BACKGROUND OF THE INVENTION

### Field of the Invention

The invention relates in general to a cooling tower control method and system.

### Description of the Related Art

Within the various industries, cooling tower has been widely used. The control mechanism of the cooling tower includes: water inlet amount control and fan motor current. Through the control mechanism of the cooling tower, the water outlet temperature can be controlled to be lower than a predetermined temperature.

Currently, the control mechanism of the cooling tower is manually controlled. After relevant data are detected using a sensor, control parameters are manually adjusted based on loading and experience.

However, such manual control/adjustment may not really lead to a best energy-saving situation. That is, although the water outlet temperature can be controlled to be lower than a predetermined temperature through manual control/adjustment, the control parameters obtained through manual control may not be the best energy-saving situation.

Therefore, the industries have been trying to operate the control mechanism of the cooling tower through artificial intelligence (AI) to assure that the cooling tower can operate under the most energy-saving situation.

### SUMMARY OF THE INVENTION

The invention is directed to a cooling tower control method and system. Cooling tower information, such as water flow rate, water outlet temperature, wet-bulb temperature and fan motor current, are obtained by sensors. A model is created using a deep learning method based on historical data, and is regularly re-trained based on the most updated data to improve prediction accuracy. After the user sets a target water outlet temperature, the control method and system automatically optimizes the control parameter combinations of the cooling tower, and then selects and feeds back a best energy-saving (lowest cost) control parameter combination from the control parameter combinations matching the target water outlet temperature to the user, so that the cooling tower can operate in the most energy-saving state.

According to one embodiment of the present invention, a cooling tower control method for controlling a cooling tower having at least one sensor is provided. The cooling tower control method includes: receiving and processing a received sensor data; regularly training a water outlet temperature prediction model based on the received sensor data; receiving a target water outlet temperature; traversal searching a plurality of control parameter combinations meeting the target water outlet temperature; selecting a best energy-saving target control parameter combination from the control parameter combinations meeting the target water outlet temperature; and controlling the cooling tower based on the target control parameter combination.

According to another embodiment of the present invention, a cooling tower control system for controlling a cooling tower having at least one sensor is provided. The cooling tower control system includes: a sensor data receiving and processing module used for receiving and processing a received sensor data; a water outlet temperature predicting module used for regularly training a water outlet temperature prediction model based on the received sensor data; a traverse searching module used for traversal searching a plurality of control parameter combinations meeting a target water outlet temperature; and a selection module used for selecting a best energy-saving target control parameter combination from the control parameter combinations meeting the target water outlet temperature, wherein, the cooling tower control system controls the cooling tower based on the target control parameter combination.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a flowchart of a cooling tower control method according to an embodiment of the present invention.

FIG. 2 is a detailed flowchart of receiving and processing sensor data and regularly training “a water outlet temperature prediction model” according to an embodiment of the present invention.

FIG. 3 is a detailed flowchart of “traversal searching all control parameters matching a target water outlet temperature” according to an embodiment of the present invention.

FIG. 4 is a detailed flowchart of “selecting the most energy-saving control parameter combination” according to an embodiment of the present invention.

FIG. 5 is a functional block diagram of a cooling tower control system according to an embodiment of the present invention.

FIG. 6 is a schematic diagram of an operating interface of the cooling tower system according to an embodiment of the present invention.

### DETAILED DESCRIPTION OF THE INVENTION

Technical terms are used in the specification with reference to the prior art used in the technology field. For any terms described or defined in the specification, the descriptions and definitions in the specification shall prevail. Each embodiment of the present disclosure has one or more technical features. Given that each embodiment is implementable, a person ordinarily skilled in the art can selectively implement or combine some or all of the technical features of any embodiment of the present invention.

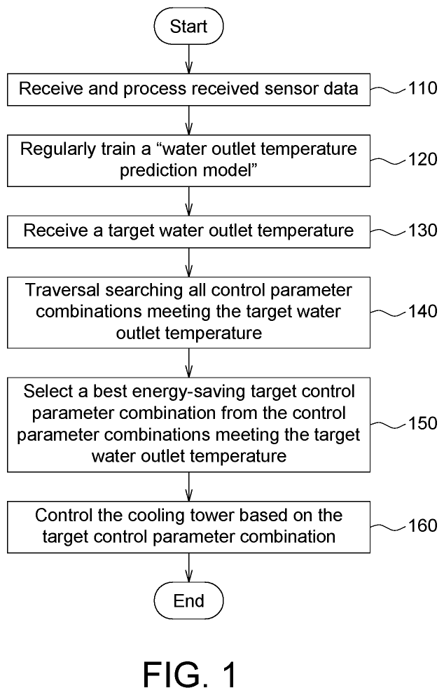

FIG. 1 is a flowchart of a cooling tower control method according to an embodiment of the present invention. The cooling tower has several types of sensors installed thereon, including but not limited to flowmeter, thermometers, wet-bulb thermometer, and current sensor.

Refer to FIG. 1. In step 110, a sensor data is received and processed. The received sensor data includes but not limited to water flow rate, water inlet temperature, water outlet temperature, wet-bulb temperature, and fan motor rotating speed. In an embodiment of the present invention, sensor data processing includes but is not limited to abnormal data elimination and data normalization. Abnormal data elimination includes but is not limited to eliminating outlier data so that the model can have better performance.

In step 120, “the water outlet temperature prediction model” is regularly trained based on the received sensor data. In step 120, a water outlet temperature prediction model is created through deep learning, and the neural network is automatically optimized to obtain an optimized prediction result.

In step 130, the target water outlet temperature set by the user is received.

In step 140, all control parameter combinations matching the target water outlet temperature are traversal searched. Here, “control parameter combinations” includes but is not limited to a combination of water flow rate parameters and fan motor current (frequency) parameters, wherein, the fan motor current (frequency) parameter can control the fan rotating speed. In step 140, given that the water outlet temperature and the wet-bulb temperature remain unchanged, a plurality of control parameter combinations of various water flow rate parameters and various fan motor current (frequency) parameters within a predetermined range are formed to obtain all control parameter combinations matching the target water outlet temperature.

In step 150, the best energy-saving control parameter combination (also referred as the target control parameter combination) is selected from all control parameter combinations matching the target water outlet temperature.

In step 160, the water flow rate and the fan rotating speed of the cooling tower are controlled according to target control parameter combination. In an embodiment of the present invention, the water flow rate and the fan rotating speed of the cooling tower can be manually or automatically controlled based on the target control parameter combination.

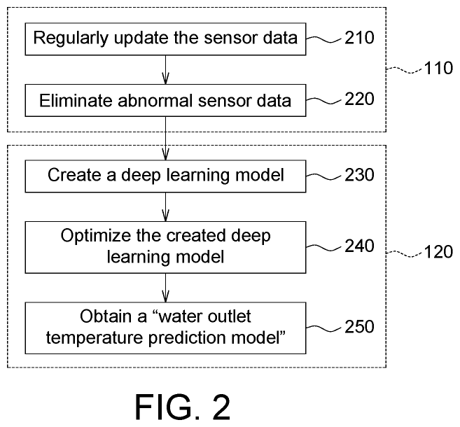

Referring to FIG. 2, a detailed flowchart of receiving and processing a received sensor data (step 110) and regularly training “the water outlet temperature prediction model” (step 120) according to an embodiment of the present invention is shown. As indicated in FIG. 2, the step of receiving and processing the received sensor data (step 110) includes: regularly updating sensor data (step 210), and eliminating abnormal sensor data (step 220). In an embodiment of the present invention, the step of regularly updating sensor data (step 210) includes but is not limited to regularly updating the received sensor data monthly or quarterly.

The step of regularly training “the water outlet temperature prediction model” (step 120) includes: creating a deep learning model (step 230) and optimizing the created deep learning model (step 240) to obtain a “water outlet temperature prediction model” (step 250).

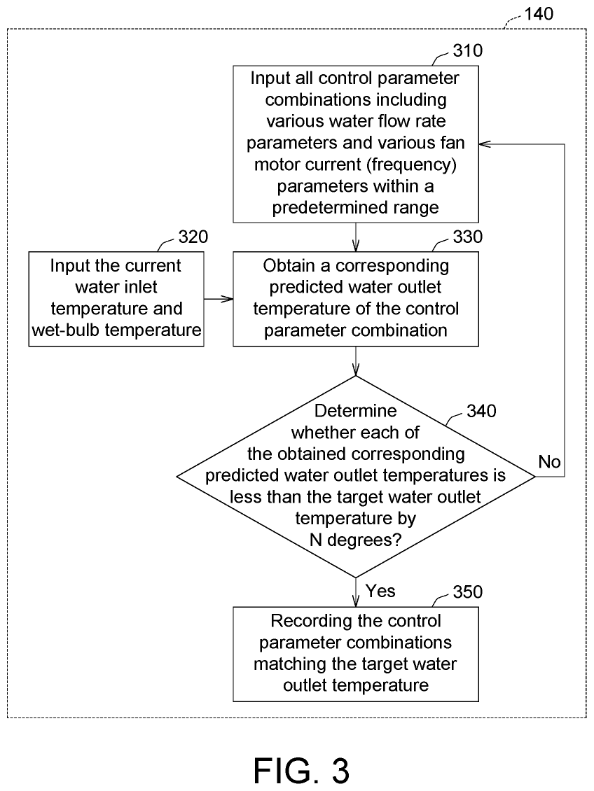

Referring to FIG. 3, a detailed flowchart of “traversal searching all control parameters matching the target water outlet temperature” (step 140) according to an embodiment of the present invention is shown. As indicated in FIG. 3, the step of “traversal searching all control parameters matching the target water outlet temperature” (step 140) includes: inputting all control parameter combinations including various water flow rate parameters (also referred as the first control parameter) and various fan motor current (frequency) parameters (also referred as the second control parameter) within a predetermined range (step 310); inputting the current water inlet temperature and wet-bulb temperature (step 320); for each control parameter combination, obtaining a corresponding predicted water outlet temperature of the control parameter combination based on the water outlet temperature prediction model (step 330); determining whether each of the obtained corresponding predicted water outlet temperatures is less than the target water outlet temperature by N degrees (N is a positive integer, such as but is not limited to 1) (in step 340, a relationship between each of the obtained corresponding predicted water outlet temperatures and the target water outlet temperature is determined) and recording the control parameter combinations matching the target water outlet temperature (step 350). Details of steps 310-350 are disclosed below.

Details of the step of inputting all control parameter combinations including various water flow rate parameters and various fan motor current (frequency) parameters within a predetermined range (step 310) are disclosed below. The predetermined range of water flow rate includes but is not limited to 1000-2000 M³/H (cubic meter per hour). If the water flow rate changes every 100 M³/H, there will be 11 water flow rate parameters (1000, 1100, 1200, 1300, 1400, . . . , 2000). Similarly, the predetermined range of fan motor current (frequency) includes but is not limited to 30-60 Hz. If the fan motor current (frequency) changes every 10 Hz, there will be 4 fan motor current (frequency) parameters (30, 40, 50, 60 Hz). There are 44 control parameter combinations including the water flow rate parameters (11 parameters) and the fan motor current (frequency) parameters (4 parameters). That is, the water flow rate parameter (1000) and the fan motor current (frequency) parameter (30) are one of the combinations; the water flow rate parameter (1100) and the fan motor current (frequency) parameter (30) are another one of the combinations, and the rest can be obtained by analogy.

Details of the step of obtaining, for each control parameter combination, a corresponding predicted water outlet temperature of the control parameter combination (step 330) are disclosed below. In the above example, based on the water outlet temperature prediction mode, the first water outlet temperature corresponding to water flow rate parameter (1000) and the fan motor current (frequency) parameter (30) is obtained and the second water outlet temperature corresponding to water flow rate parameter (1100) and the fan motor current (frequency) parameter (30) is obtained. By the same analogy, water outlet temperatures corresponding to all control parameter combinations are obtained. In the above example, in response to the 44 control parameter combinations, 44 water outlet temperatures need to be obtained.

Details of steps 340 and 350 are disclosed below. In the above example, it is exemplified that the target water outlet temperature is 25° C. and N=1, but the present invention is not limited thereto. For each of the 44 water outlet temperatures corresponding to 44 parameter combinations, whether each of the predicted water outlet temperature is less than the target water outlet temperature by 1 degree is determined (that is, whether the predicted water outlet temperatures is within the range of 24-25° C. is determined). The control parameters whose corresponding predicted water outlet temperatures differ with the target water outlet temperature within N degrees are recorded.

The table below shows the control parameter combinations and the predicted water outlet temperatures according to an embodiment of the present invention.

| | Index | | | |
|---|---|---|---|---|
| | 0 | 1 | 2 | 3 |
| Creation time | XXX | XXX | XXX | XXX |
| Water inlet | 31.531 | 31.531 | 31.531 | 31.531 |
| temperature | | | | |
| Predicted | 29.15 | 29.15 | 29.162 | 29.15 |
| water outlet | | | | |
| temperature | | | | |
| First fan motor | 67.995 | 67.5 | 68.145 | 68.265 |
| current | | | | |
| (frequency) | | | | |
| parameter | | | | |
| Water flow | 1435.688 | 1478.062 | 1485.938 | 1488.25 |
| rate | | | | |
| parameter | | | | |
| Second fan | 64.875 | 64.912 | 95.562 | 65.65 |
| motor current | | | | |
| (frequency) | | | | |
| parameter | | | | |
| Wet-bulb | 26.954 | 26.935 | 26.996 | 26.971 |
| temperature | | | | |

It can be known from the above table that in an embodiment of the present invention, corresponding water outlet temperature for each control parameter combination can be predicted.

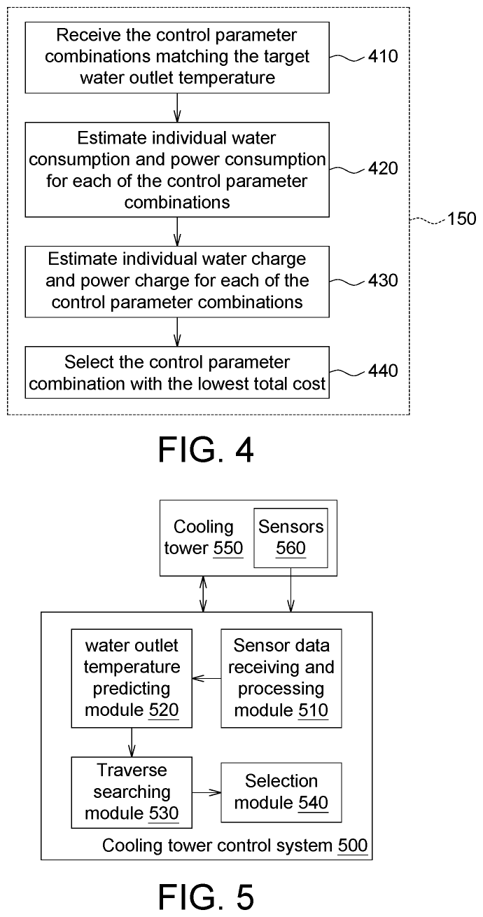

Referring to FIG. 4, a detailed flowchart of “selecting the best energy-saving control parameter combination (also referred as the target control parameter combination)” (step 150) according to an embodiment of the present invention is shown. As indicated in FIG. 4, “selecting the best energy-saving control parameter combination (also referred as the target control parameter combination)” (step 150) includes but is not limited to receiving the control parameter combinations matching the target water outlet temperature (step 410); estimating individual water consumption and power consumption for each of the control parameter combinations (step 420); estimating individual water charge and power charge for each of the control parameter combinations (step 430); and selecting the control parameter combination with the lowest total cost (step 440).

FIG. 5 is a functional block diagram of a cooling tower control system according to an embodiment of the present invention. As indicated in FIG. 5, the cooling tower control system 500 can control a cooling tower 550. The cooling tower 550 has several sensors 560 installed thereon.

The cooling tower control system 500 includes: a sensor data receiving and processing module 510, a water outlet temperature predicting module 520, a traverse searching module 530 and a selection module 540. The sensor data receiving and processing module 510 can perform step 110. The water outlet temperature predicting module 520 can perform step 120. The traverse searching module 530 can perform step 140. The selection module 540 can perform step 150. Details of sensor data receiving and processing module 510, the water outlet temperature predicting module 520, the traverse searching module 530 and the selection module 540 are not repeated here.

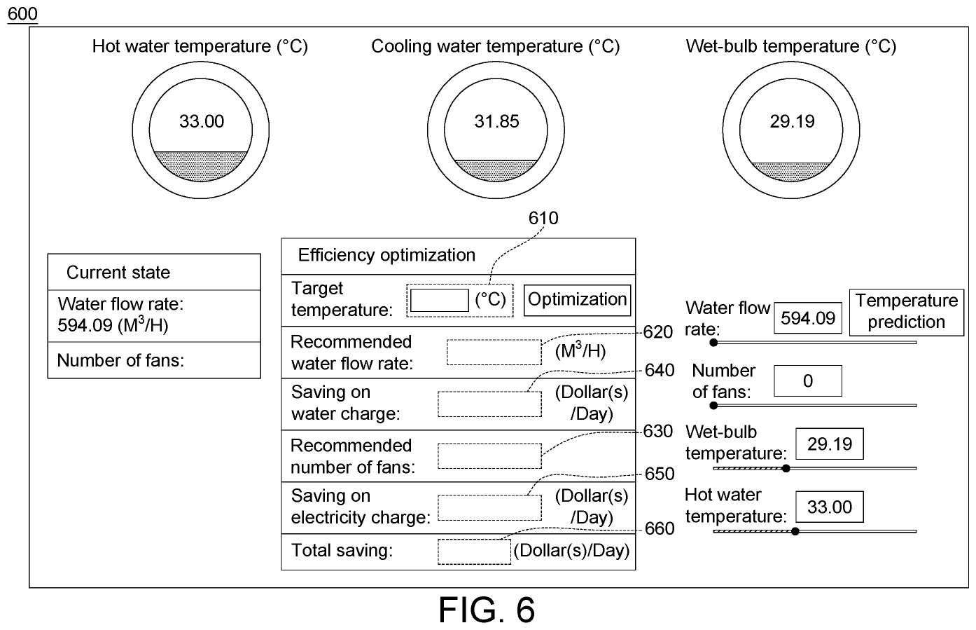

FIG. 6 is a schematic diagram of an operating interface 600 of the cooling tower system according to an embodiment of the present invention. As indicated in FIG. 6, the user can input a target water outlet temperature to the column 610. After calculation, the cooling tower system respectively displays a recommended control parameter (water flow rate control parameter and a fan motor current control parameter) on columns 620 and 630. Additionally, the cooling tower system can display the saved water and electricity charges and the total cost on columns 640, 650 and 660 respectively.

According to the above embodiments of the present invention, control parameters are optimized so that energy and cost can be saved. After the user sets a target water outlet temperature, the control method according to the above embodiments of the present invention not only feeds back control parameters of the cooling tower based on the history data trend, but also calculates possible water charge and power charge corresponding to each of the control parameter combinations, and selects a best solution among the control parameter combinations. Therefore, the above embodiments of the present invention have the advantage of energy saving and cost saving.

Besides, according to an embodiment of the present invention, the control parameter includes a fan inverter motor current parameter and a water inlet amount parameter. The control method can optimize the fan motor current and the water inlet amount and has outstanding efficiency of energy saving.

Moreover, in an embodiment of the present invention, the water outlet temperature prediction model of the cooling tower can be regularly updated through a neural network; the newest data are updated to the water outlet temperature prediction model of the cooling tower monthly (or quarterly), the water outlet temperature prediction model of the cooling tower is regularly re-trained, so that future prediction can be more accurate.

Also, in an embodiment of the present invention, optimal parameter is searched in a “traverse” manner, the control parameter combinations matching the target water outlet temperature are selected from all control parameter combinations including the water inlet amounts and the fan motor currents with reference to the current wet-bulb temperature and water inlet temperature, then savings in electricity and water charges are calculated to select the best (target) control parameter combination (lowest total electricity and water charges).

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A cooling tower control method for controlling a cooling tower having at least one sensor, the cooling tower control method including:
receiving and processing a received sensor data;
regularly training a water outlet temperature prediction model based on the received sensor data;
receiving a target water outlet temperature;
traversal searching a plurality of control parameter combinations meeting the target water outlet temperature;
selecting a best energy-saving target control parameter combination from the control parameter combinations meeting the target water outlet temperature; and
controlling the cooling tower based on the target control parameter combination.

2. The cooling tower control method according to claim 1, wherein, the step of receiving and processing the received sensor data comprises:
regularly updating the sensor data; and
eliminating abnormal sensor data.

3. The cooling tower control method according to claim 2, wherein, the step of regularly training the water outlet temperature prediction model comprises:
creating a deep learning model;
optimizing the created deep learning model; and
obtaining the water outlet temperature prediction model.

4. The cooling tower control method according to claim 3, wherein, the step of traversal searching the control parameter combinations meeting the target water outlet temperatures comprises:
inputting the control parameter combinations including a plurality of first control parameters and a plurality of second control parameters within a predetermined range;
inputting a current water inlet temperature and a wet-bulb temperature;
for each of the control parameter combinations, obtaining a corresponding predicted water outlet temperature of the control parameter combination based on the water outlet temperature prediction model;
determining a relationship between each of the obtained corresponding predicted water outlet temperatures and the target water outlet temperature; and
recording the control parameter combinations meeting the target water outlet temperature.

5. The cooling tower control method according to claim 4, wherein, the step of selecting the best energy-saving target control parameter combination comprises:
receiving the control parameter combinations meeting the target water outlet temperature;
estimating individual water consumption and power consumption for each of the control parameter combinations;
estimating individual water charge and power charge for each of the control parameter combinations; and
selecting the target control parameter combination with a lowest total cost.

6. A cooling tower control system for controlling a cooling tower having at least one sensor, the cooling tower control system including:
a sensor data receiving and processing module used for receiving and processing a received sensor data;
a water outlet temperature predicting module used for regularly training a water outlet temperature prediction model based on the received sensor data;
a traverse searching module used for traversal searching a plurality of control parameter combinations meeting a target water outlet temperature; and
a selection module used for selecting a best energy-saving target control parameter combination from the control parameter combinations meeting the target water outlet temperature,
wherein, the cooling tower control system controls the cooling tower based on the target control parameter combination.

7. The cooling tower control system according to claim 6, wherein, the sensor data receiving and processing module is used for:
regularly updating the sensor data; and
eliminating abnormal sensor data.

8. The cooling tower control system according to claim 7, wherein, the water outlet temperature predicting module is used for:
creating a deep learning model;
optimizing the created deep learning model; and
obtaining the water outlet temperature prediction model.

9. The cooling tower control system according to claim 8, wherein, the traverse searching module is used for:
inputting the control parameter combinations including a plurality of first control parameters and a plurality of second control parameters within a predetermined range;
inputting a current water inlet temperature and a wet-bulb temperature;
for each of the control parameter combinations, obtaining a corresponding predicted water outlet temperature of the control parameter combination based on the water outlet temperature prediction model;
determining a relationship between each of the obtained corresponding predicted water outlet temperatures and the target water outlet temperature; and
recording the control parameter combinations meeting the target water outlet temperature.

10. The cooling tower control system according to claim 9, wherein, the selection module is used for:
receiving the control parameter combinations meeting the target water outlet temperature;
estimating individual water consumption and power consumption for each of the control parameter combinations;
estimating individual water charge and power charge for each of the control parameter combinations; and
selecting the target control parameter combination with a lowest total cost.
